(19) United States
(12) Patent Application Publication
(10) Pub. No.: US 2026/0016650 A1
(43) Pub. Date: Jan. 15, 2026

(54) MULTICORE FIBER STRANDS FOR FIBER OPTIC COMMUNICATION

(71) Applicant: Optical Cable Corporation, Roanoke, VA (US)

(72) Inventors: Teddy W. Leonard, Wirtz, VA (US); Michael A. Stover, Prosper, TX (US)

(73) Assignee: Optical Cable Corporation, Roanoke, VA (US)

(21) Appl. No.: 19/267,185

(22) Filed: Jul. 11, 2025

Related U.S. Application Data
(60) Provisional application No. 63/670,094, filed on Jul. 11, 2024.

(51) Int. Cl. G02B 6/44

(52) U.S. Cl. CPC G02B 6/443; G02B 6/4486

(57) ABSTRACT

Systems, methods, and other embodiments associated with a multicore fiber optic device for deployment in the field and in harsh environments. In one embodiment, an optical fiber device includes an optical fiber strand configured to include a light guiding core. The light guiding core is positioned within and enclosed by the optical fiber strand and provides an optical waveguide. The optical fiber device can further include an outer protective layer configured to enclose the optical fiber strand and the light guiding core. In the example optical fiber device, the optical fiber strand, the light guiding core, and the outer protective layer extend along a same axis. The optical fiber device can be configured to include multiple light guiding cores, protection layers, and deployment layers for field deployment and protection from harsh environments.

### RELATED APPLICATION

This application claims priority to and incorporates entirely by reference U.S. Provisional Patent Application Ser. No. 63/670,094 filed on Jul. 11, 2024, entitled “Deployable Cable and Connectivity with Multicore Optical Fibers.”

### TECHNICAL FIELD

The embodiments generally relate to cable constructions for field deployment that can include fiber optic devices, cables, and systems. In particular, the embodiments generally relate to device, methods, and systems for constructing fiber optic cables having one or more light guiding cores (e.g., multiple cores) embedded within a fiber optic strand of the fiber optic cable.

### BACKGROUND

In present fiber optic cables and devices, high bandwidth and widespread local connectivity can be achieved using large bundles of individual fiber optic strands (i.e., high fiber counts) and various network configurations and technologies. Additionally, the fiber optic strands are bundled together for protection and strength. Generally, high fiber counts can be deployed to provide a backbone for local area networks (LANs), communities, buildings, campuses, and institutions. Typically, when fiber optic cables and fiber optic devices (e.g., multiplexing devices, multiplexers, demultiplexers, amplifiers, etc.,) are deployed, the fiber optic installation may be installed in configurations having excess or unused fiber to allow for expansion and connection redundancy. Conventional fiber optic cable is constructed of a bundle of optical fiber strands. Each optical fiber strand is commonly made of silica (glass) or plastic for shorter distances. A given fiber optic cable can contain one, two, or many fiber strands grouped or organized together within the cable. Each glass fiber strand contains one core optical waveguide, and each core optical waveguide transmits data or information. However, with exponential growth in connectivity and bandwidth demands, some problems do exist with current fiber optic cables.

Current fiber optic cables use glass fiber strands with one core optical waveguides. As network connectivity demands grow, new deployment of current fiber optic cables can often require heavy, thick optical fiber cables with high fiber counts to withstand environmental conditions and provide for connection redundancy, expansion, and greater bandwidth demands. One problem with these high fiber count optical cables, involves use of numerous buffer tubes, strength members, fillers, and armor to group, organize, and protect each glass fiber strand. Since deployment of fiber optic cables can require hundreds or thousands of kilometers of fiber optic cable from one area network to another area network and back to the backbone. There is high cost and limited efficiency involved in deploying and installing high fiber count fiber optic cabling as connectivity is limited by each optical fiber (glass fiber strand) to one optical waveguide.

Another problem with current fiber optic cables involves retrieval of existing deployed fiber optic cables in order to deploy higher fiber count fiber optic cables. With the regular influx of technological innovations and trends, anticipating network usage and traffic can be very challenging. In many connected locations, deployment of upgraded or modified high fiber bundle cables to accommodate increases in network connectivity and traffic can be very difficult and costly. For example, deployment in underground, aerial, submarine, and other types of deployment within existing infrastructure can often require long term cable construction projects that can be costly, time consuming, and inconvenient. Moreover, in some locations space and underground clearance can be very limited and may not be able to accommodate larger or thicker fiber optic cable runs. Therefore, there is a need for a fiber optic cable that can provide for connection redundancy, facilitate expansion of a network into other areas, and accommodate greater connectivity and bandwidth demands without requiring additional space and incurring significant deployment costs. Moreover, there is a need for a simple design that can reduce or eliminate the need for numerous buffer tubes, strength members, fillers, and armor that is needed to group, organize, and protect each glass fiber strand in a high fiber count fiber optic cable.

### SUMMARY

In an implementation, a device including one or more optical fiber strands that form a fiber optic cable. An optical fiber strand being configured to include one or more light guiding cores, each light guiding core positioned within, and enclosed by, the optical fiber strand; and an outer protective layer configured to enclose the optical fiber strand and the light guiding core; wherein the light guiding core provides an optical waveguide; and wherein the optical fiber strand, the light guiding core, and the outer protective layer extend along a same axis.

In another implementation, a method including forming a light guiding core; configuring the light guiding core to provide an optical waveguide; forming an optical fiber strand to enclose the light guiding core; and forming an outer protective layer, the outer protective layer configured to enclose the optical fiber strand and the light guiding core; wherein the optical fiber strand, the light guiding core, and the outer protective layer extend along a same axis.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1 illustrates one embodiment of a plan view of an optical fiber device with one or more light guiding cores that can provide for connection redundancy, facilitate expansion of a network into other areas, and accommodate greater connectivity and bandwidth demands, in accordance with aspects of the present disclosure;

FIG. 2 illustrates one embodiment of a plan view of an optical fiber device with one or more light guiding cores that can provide for connection redundancy, facilitate expansion of a network into other areas, and accommodate greater connectivity and bandwidth demands, in accordance with aspects of the present disclosure;

FIG. 3 illustrates one embodiment of a plan view of an optical fiber device with one or more light guiding cores for facilitating connection redundancy, expansion, and accommodating greater connectivity and bandwidth demands, in accordance with aspects of the present disclosure;

FIG. 4A illustrates one embodiment of a plan view of a fiber optic cable with a multicore optical fiber strand, in accordance with aspects of the present disclosure;

FIG. 4B illustrates one embodiment of front view of a fiber optic cable with a multicore optical fiber strand, in accordance with aspects of the present disclosure;

FIG. 5 illustrates one embodiment of a plan view of a fiber optic cable with multicore optical fiber strands, in accordance with aspects of the present disclosure;

FIG. 6 illustrates one embodiment of a plan view of a fiber optic cable with multicore optical fiber strands, in accordance with aspects of the present disclosure;

FIG. 7 illustrates one embodiment of a front view of a high fiber-count fiber optic device having multicore optical fiber strands, the fiber optic device can provide for connection redundancy, facilitate expansion of a network into other areas, and accommodate greater connectivity and bandwidth demands; and

FIG. 8 illustrates one embodiment of a flowchart depicting a process for manufacturing a fiber optic cable with multicore optical fiber strands that can provide for connection redundancy, facilitate expansion of a network into other areas, and accommodate greater connectivity and bandwidth demands, in accordance with aspects of the present disclosure.

### DETAILED DESCRIPTION

Systems and methods are described herein as associated with fiber optic cables with multicore optical fiber strands that can provide for connection redundancy, facilitate expansion of a network into other areas, and accommodate greater connectivity and bandwidth demands, and other qualities and features as described herein for depositing a patterned powder. Current high fiber count cables are limited to single core fiber strands for providing connection redundancy and network connectivity which can often be a bottleneck when deploying fiber optic cabling to facilitate expansion of a network into other areas and accommodate greater connectivity and bandwidth demands. Adding more fiber strands to current fiber optic cables to accommodate greater connectivity and bandwidth demands also requires adding more buffer tubes, strength members, and armor to protect the fiber optic cable and the additional fiber strands. Since, deployment of fiber optic cables may require hundreds or thousands of kilometers of fiber optic cable from one area network to another area network and back to the backbone. There can often be high cost and limited efficiency associated with deploying and installing current fiber optic cables as connectivity is limited by each optical fiber (glass fiber strand) to one optical waveguide. Further, in populated locations, digging through existing infrastructure and deploying higher fiber bundle counts can be very costly, time consuming, and inconvenient. Moreover, in some locations space and underground clearance can be very limited and may not be able to accommodate thicker fiber optic cable runs that are typically needed to protect single core fiber strands and optical fiber cabling. In certain densely populated locations, deploying such denser or thicker fiber optic cable can be prohibitively expensive.

The present disclosure solves these problems and others using multicore optical fiber strands within a fiber optic cable. The multicore fiber optic cable provides a simple design that can reduce or eliminate the need for numerous buffer tubes, strength members, fillers, and armor to group, organize, and protect each glass fiber strand. Other benefits and advantages of the multicore fiber optic cable are described herein. Moreover, the multicore fiber optic cable can be designed for a deployable/harsh environment by consolidating multiple light guiding cores into a cable with a smaller form factor. The multicore fibers of the present disclosure are designed to offer multiple connectivity and higher bandwidth capacity compared to traditional optical fibers of the same size and weight. Further, utilization of multicore optical fiber has advantages anywhere size and weight are important considerations, especially where the multicore fiber and optional connectivity are incorporated into a field deployable or harsh environment rated cable or cable assembly. Further, transition fiber can be spliced to the multicore fiber at the fiber optic cable ends to transition into individual single core fibers, one single core fiber corresponding to each core of the multicore fiber.

### Multicore Optical Fiber Strands

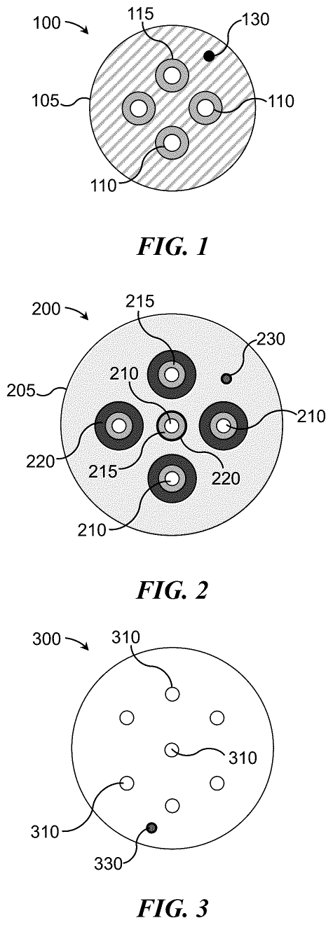

FIG. 1 illustrates one embodiment of a plan view of an optical fiber device with one or more light guiding cores for providing connection redundancy, facilitating expansion of a network into other areas, and accommodate greater connectivity and bandwidth demands, in accordance with aspects of the present disclosure. In some implementations, an optical fiber device 100 may include one or more optical fiber strands 105, each optical fiber strand 105 being configured to include one or more light guiding cores 110, a cladding 115, and one or more rip cords 130. Each light guiding core 110 being positioned within the optical fiber strand 105 and providing an optical waveguide to facilitate fiber optic communication. As is known in the art, each light guiding core may be enclosed by the cladding 115 and further coated by an optical fiber coating (not shown) such as an optical fiber acrylate coating. The one or more rip cords 130 may be accessed and used to open the optical fiber strand 105 to allow modifications and/or access to one or more light guiding cores 110. Further, each light guiding core 110 may be made of glass (e.g., silica) or plastic material. Moreover, in certain implementations, one or more light guiding cores 110 may be configured to have the same shape or form as the optical fiber strand 105. In some implementations, one or more light guiding cores 110 may be configured to have a different shape or form from the optical fiber strand 105. As some examples, in one implementation, the cross-sectional shape of one or more light guiding cores 110 may be configured as a cylindrical, elliptical, square, rectangular, octagonal, polygonal, or strip or adjoining strip segments extending along the same axis as the optical fiber strand 105. In some implementations, the optical fiber device 100 may include a buffer layer that encloses the optical fiber strand 105, the buffer layer may be configured as a tight elastomer buffer. In some embodiments, the buffer may be helically stranded. In one implementation, the optical fiber device 100 may be implemented in a fiber optic cable whereby the optical fiber strand 105, one or more light guiding cores 110, cladding 115, and one or more rip cords 130 extend along the same axis as the fiber optic cable.

Referring to FIG. 1, in a further aspect of the disclosure, the optical fiber strand 105 may be configured to include four optical waveguides, one per light guiding core 110, to achieve a size and weight reduction per optical waveguide glass strand by a factor of 4. In various implementations, an optical fiber strand may be defined with a range of between 80 μm to 500 μm. In various implementations, a light guiding core may be defined with a range of between 2 μm to 400 μm. As is readily contemplated, each optical fiber strand 105 within a fiber optic cable may be individually configured as needed to include one or more light guiding cores 110. As an example, optical fiber strands 105 having four light guiding cores 110 can allow deployment of fiber optic cables with hundreds of optical fiber strands instead of thousands of fiber stands. The smaller fiber counts facilitate smaller cable diameters and reduction in fiber optic cable weight allowing for improved deployment and retrieval of multicore fiber optic cable. Further, the size, dimension, shape, or form of each light guiding core 110 within an optical fiber strand 105 may be individually configured as needed to provide multiple connectivity, higher bandwidth capacity, connection redundancy, or any combinations thereof.

Each multicore optical fiber strand 105 may further facilitate efficient use of space, for example, around existing infrastructure, in locations with harsh environments, or in locations where size and weight are important considerations for deploying fiber optic cables or upgrading existing installations. Moreover, in many implementations, the optical device 100 may be enclosed with additional layers of metal, polymer, fiberglass, plastic, glass, or any combinations thereof. As an example, the optical device 100 may be enclosed by one or more protective layers such as a braided steel, bronze armor wire, a fiberglass yarn layer, aramid layer, acrylate coating/layer, a polymer layer, a polyurethane outer protective layer, and so forth. The protective layers (e.g., deployment layers) may provide cut resistance and rodent protection by, for example and not limited to, incorporating braided steel or bronze armor wire over the optical device 100, or a fiberglass yarn layer over the optical device, with another polyurethane jacket over the braided wire or fiberglass yarn, or a hard cut-resistant polymer covering the light guiding cores.

FIG. 2 illustrates one embodiment of a plan view of an optical fiber device with one or more light guiding cores for providing connection redundancy, facilitating expansion of a network into other areas, and accommodate greater connectivity and bandwidth demands, in accordance with aspects of the present disclosure. In some implementations, an optical fiber device 200 may include one or more optical fiber strands 205, each optical fiber strand 205 may be configured to include one or more light guiding cores 210, a cladding 215, a protective layer 220, and a rip cord 230. In many implementations, each light guiding core 210 may be enclosed by a cladding 215 and a protective layer 220. Moreover, the protective layer 220 may be a coating layer such as optical fiber acrylate coating. The rip cord 230 may be accessed and used to open the optical fiber strand 205 to allow modifications and/or access to one or more light guiding cores 210.

In a further aspect of the disclosure, in some implementations, the optical fiber device 200 may be implemented as a fiber optic cable whereby an outer protective layer encloses the one or more optical fiber strands 205 and the components of each optical fiber strand 205 including one or more optical fiber strands 205, light guiding cores 210, cladding 215, protective layers 220, and one or more rip cords 230. Moreover, the components of the optical fiber strands 205 may be configured to extend along the same axis as the optical fiber device 200 (e.g., fiber optic cable). Further, the optical fiber device 200 may include one or more outer protective layers configured as a polyurethane outer jacket in order to withstand harsh environments such as vibrations, harsh temperatures, humidity, UV, fungus, and chemical exposures. Moreover, the light guiding cores 210 and/or protective layer 220 may be further enclosed by a braided steel mesh, bronze armor wire, a fiberglass yarn layer, aramid layer, acrylate coating/layer, a polymer layer, a polyurethane outer protective layer, or any combinations thereof.

FIG. 3 illustrates one embodiment of a plan view of an optical fiber device with one or more light guiding cores for providing connection redundancy, facilitating expansion of a network into other areas, and accommodate greater connectivity and bandwidth demands, in accordance with aspects of the present disclosure. In some implementations, an optical fiber device 300 may include one or more optical fiber strands 305 configured to seven or more light guiding cores 310 (seven or more optical waveguides), to achieve a size and weight reduction per optical waveguide glass strand by a factor of 7, as an example. Each of a plurality of light guiding cores 310 may be positioned as desired. For example, one light guiding core 310 may be positioned to extend along the central axis. In some embodiments, light guiding cores 310 may be positioned equidistant from one another. Further, in certain implementations, one or more light guiding cores 310 may be offset by a predetermined distance from the central axis. In some implementations, the central axis may include a buffer layer and/or strength member to protect the light guiding cores 310 from damage. As is readily contemplated, each optical fiber strand 305 within an optical fiber device 300 may be individually positioned and configured as needed to include a plurality of light guiding cores 110 to facilitate ease in deployment/retrieval as well as provide multiple connectivity, higher bandwidth capacity, connection redundancy, or any combinations thereof.

### Multicore Fiber Strands and Fiber Optic Cables

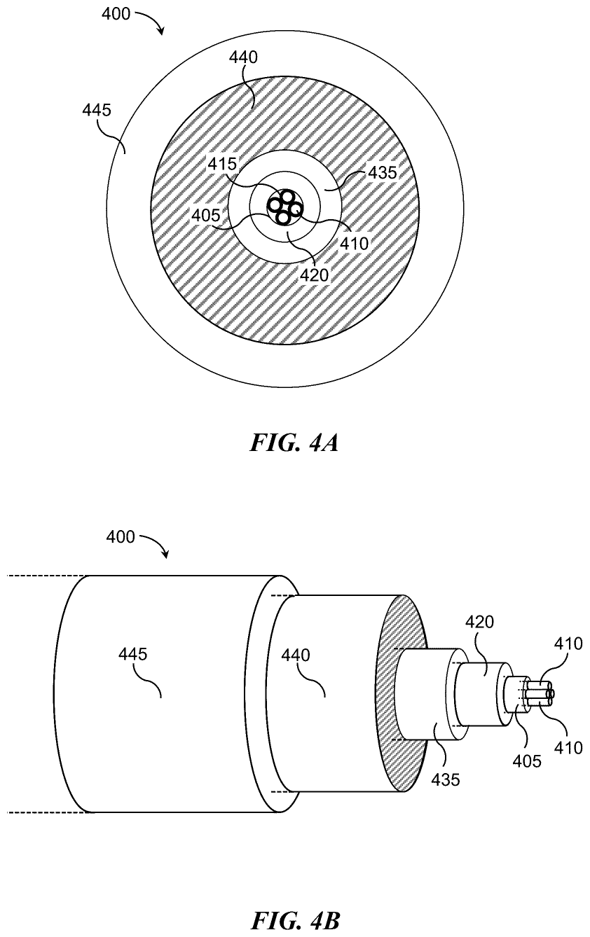

With reference to FIGS. 4A-4B, one embodiment of a fiber optic cable with a multicore optical fiber strand is illustrated, in accordance with aspects of the present disclosure. In some implementations, an optical fiber device 400 may include one or more optical fiber strands 405, each optical fiber strand 405 may be configured to include one or more light guiding cores 410, a cladding 415, a protective layer 420, a buffer 435, a strength member 440, one or more rip cords (not shown), and an outer protective layer 445. In many implementations, each light guiding core 410 may be enclosed by a cladding 415 and a protective layer 420. The protective layer 420 may be applied as a layer or coating on each optical fiber strand 405 to enclose the optical fiber strand 405 and one or more light guiding cores 410. In some embodiments, the protective layer 420 may be an optical fiber acrylate material. The optical fiber device 400 may include one or more buffers 435 that may be applied over the protective layer 420 to enclose the protective layer 420. In some embodiments, the buffer 435 may be a tight elastomer buffer. Further, optical fiber device 400 may include one or more strength members 440 that enclose the buffer 435. The strength member 440 may be made of an aramid yarn, as an example. The optical fiber device 400 may further include an outer protective layer 445 that encloses the optical fiber strand 405 and one or more light guiding cores 410. In some implementations, the outer protective layer 445 may be made of a polyurethane material. As described herein, in many embodiments the outer protective layer (or deployment layers) may be configured as a polyurethane outer jacket in order to withstand harsh environments such as vibrations, harsh temperatures, humidity, UV, fungus, and chemical exposures. Moreover, the light guiding cores, the protective layer, and/or outer protective layer may be further enclosed by deployment layers such as braided steel mesh, bronze armor wire, a fiberglass yarn layer, aramid layer, acrylate coating/layer, a polymer layer, a polyurethane outer protective layer, or any combinations thereof.

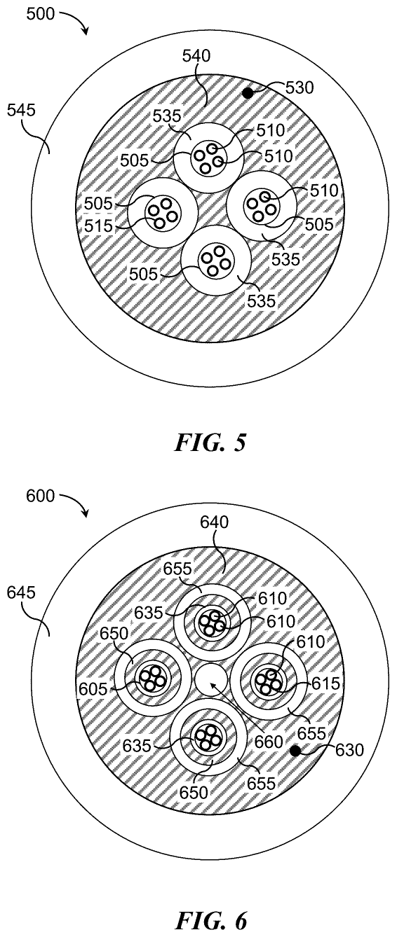

With reference to FIG. 5, one embodiment of a fiber optic cable with a multicore optical fiber strand is illustrated, in accordance with aspects of the present disclosure. In some implementations, an optical fiber device 500 may include one or more fiber optic device components such as optical fiber strands 505, light guiding cores 510, protective layers (not shown), rip cords 530, buffers 535, strength members 540, and outer protective layers 545. Each fiber optic device component may be positioned within the optical fiber device 500 and configured to extend along the same axis as the optical fiber device 500. Further, in many embodiments, each optical fiber strand 505 may be configured to include one or more light guiding cores 510, a cladding 515, a protective layer (not shown) enclosing the light guiding core 510, a buffer 535 enclosing the protective layer, a strength member 540 enclosing the buffer 535 and containing one or more rip cords 530 (not shown), and an outer protective layer 440 enclosing the strength member 540. In some embodiments, each optical fiber strand 505 may include multiple cores (light guiding cores/optical waveguides) surrounded by a buffer 535 that may be a tight elastomer buffer. In many implementations, multiple elastomer buffers may be helically stranded to enclose each optical fiber strand 505 and a portion of the strength member 540. In some embodiments, the strength member 540 may be made of an aramid yarn. Further, the jacket or outer protective layer 545 may be made of polyurethane, as an example. In various implementations, buffers 535 may be configured (or strengthened) to extend helically in the same axis as the optical fiber device 500. The buffers 535 may further be implemented to form sub-cable jackets to protect each multicore optical fiber strand 505.

With reference to FIG. 6, one embodiment of a fiber optic cable with a multicore optical fiber strand is illustrated, in accordance with aspects of the present disclosure. In some implementations, an optical fiber device 600 may include one or more fiber optic device subcomponents such as sub-cable strength members 650, sub-cable outer protective layer 655, and coaxial or inner buffer 660 to further protect each multicore optical fiber strand 605. As described herein, the optical fiber device 600 may include one or more fiber optic device components such as optical fiber strands 605, light guiding cores 610, protective layers (not shown), rip cords 630, buffers 635, strength members 640, and outer protective layers 645. In many implementations, fiber optic devices with higher fiber counts may incorporate the designs described herein as subunit cables within a single cable outer jacket. For these cables, an appropriate elastomer sub-cable jacket may be used, but the overall cable would have an outer protective layer 645 that is configured as a polyurethane outer jacket. Moreover, for the fiber optic devices described herein the multicore cables may be coupled with a short length of transition fiber that is spliced to the multicore fiber at the cable ends. This transition fiber may be configured to match with and couple to the multicore fiber optic cable end. The other side of the transition may include individual single core fibers, one corresponding to each core of the multicore fiber. In some implementations, field deployable cable assembly with connectivity may include the transition fiber incorporated into the deployable fiber optic multicore cable. Thus, the transition fiber may further include deployment layers and protections described herein to facilitate deployment in harsh environments to protect the transition device from shock, vibration, temperature, humidity, UV, fungus, and chemical exposures.

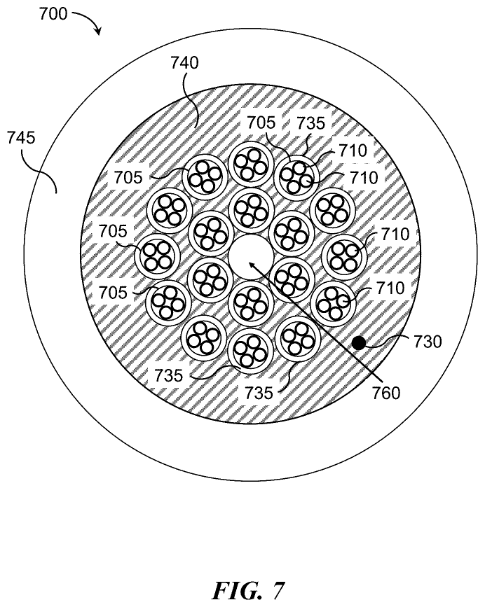

With reference to FIG. 7, one embodiment of a high fiber-count fiber optic device having multicore optical fiber strands is illustrated, the high fiber-count fiber optic device can provide for redundancy, facilitate expansion of a network into other areas, and accommodate greater connectivity and bandwidth demands, in accordance with one or more embodiments of the present disclosure. In some implementations, an optical fiber device 700 may include high count fiber optic device components such as optical fiber strands 705, light guiding cores 710, and buffers 735, as an example. The optical fiber device may include protective layers (e.g., deployment/retrieval layers) such as one or more strength members 740 and outer protective layers 745, as well as one or more coaxial or inner buffers 760 to further protect each multicore optical fiber strand 705, and one or more rip cords 730 for accessing the fiber optic device components. Each fiber optic device component may be positioned within the optical fiber device 700 and configured to extend along the same axis as the optical fiber device 700. Further, in many implementations, optical fiber device 700 may include N-fibers and N×M cores, where N≥1, M≥1, and N and M can be any positive integer greater than 0. In various implementations, the optical fiber device may include four light guiding cores 710 (M=4) and ten or more optical fiber strands 705 (N≥10). With reference again to FIG. 7, in one implementation, an 18-fiber (72 core) high fiber-count optical fiber device 700 is shown. As can be readily appreciated, many variations of sizes, dimensions, quantities, arrangements, and shapes of optical fiber strands 705 and light guiding cores 710 may be implemented. For instance, a 24-fiber optical fiber device (e.g., fiber optic cable) with 4 light guiding cores per optical fiber strand would result in a 96-core optical fiber device. Further, a 24-fiber optical fiber device (e.g., fiber optic cable) with 7 light guiding cores per optical fiber strand would result in a 168-core optical fiber device, a 48-fiber optical fiber device (e.g., fiber optic cable) with 4 light guiding cores per optical fiber strand would result in a 192-core optical fiber device, and so forth. In some embodiments, each optical fiber strand 705 may include multiple cores (light guiding cores/optical waveguides) surrounded by a buffer 735 that may be a tight elastomer buffer. In many implementations, multiple elastomer buffers may be helically stranded to enclose each optical fiber strand 705 and a portion of the strength member 740. In some embodiments, the strength member 740 may be made of an aramid yarn. Further, the jacket or outer protective layer 745 may be made of polyurethane, as an example. In various implementations, buffers 735 may be configured (or strengthened) to extend helically in the same axis as the optical fiber device 700. The buffers 735 may further be implemented to form sub-cable jackets to protect each multicore optical fiber strand 705 as described herein.

### Method for Forming Multicore Fiber Strands and Fiber Optic Cables

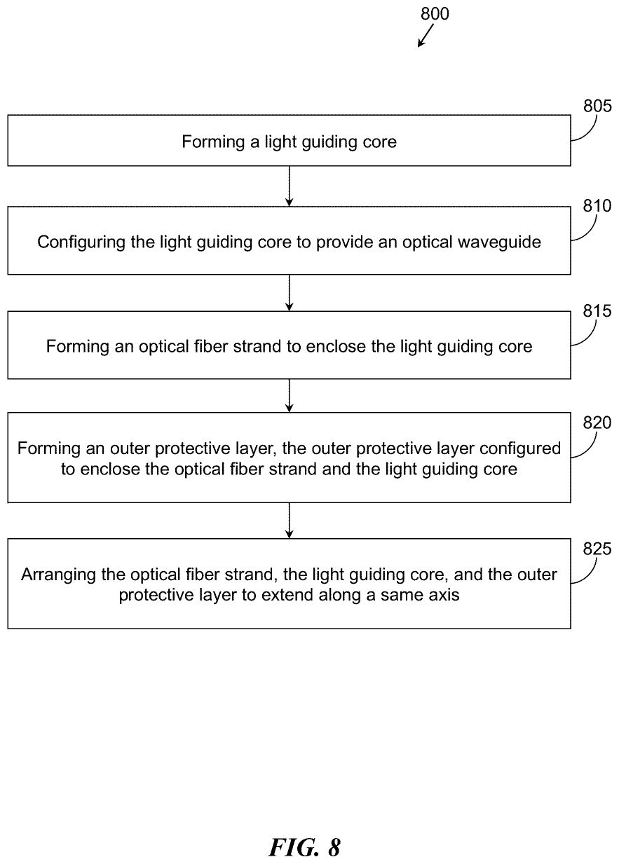

FIG. 8 illustrates an example flow chart showing a method for manufacturing a fiber optic cable with multicore optical fiber strands that can provide for redundancy, facilitate expansion of a network into other areas, and accommodate greater connectivity and bandwidth demands, in accordance with one or more embodiments of the present disclosure. These exemplary methods are provided by way of example, as there are a variety of ways to carry out these methods. Each block shown in FIG. 8 represents one or more processes, methods, or subroutines, carried out in the exemplary method. FIGS. 1-3, 4A-4B, and 5-7 show example embodiments of carrying out the method of FIG. 8 for manufacturing a fiber optic cable with multicore optical fiber strands that can provide redundancy, facilitate expansion of a network into other areas, and accommodate greater connectivity and bandwidth demands. Each block shown in FIG. 8 represents one or more processes, methods, or subroutines, carried out in the exemplary method. The exemplary method may begin at block 805. Method 800 may be used independently or in combination with other methods or process for manufacturing a fiber optic cable with multicore optical fiber strands that can provide redundancy, facilitate expansion of a network into other areas, and accommodate greater connectivity and bandwidth demands. For explanatory purposes, the example process 800 is described herein with reference to multicore optical fiber strands of FIGS. 1-3, 4A-4B, and 5-7. Further for explanatory purposes, the blocks of the example process 800 are described herein as occurring in serial, or linearly. However, multiple blocks of the example process 800 may occur in parallel. In addition, the blocks of the example process 800 may be performed in a different order than the order shown and/or one or more of the blocks of the example process 800 may not be performed. Further, any or all blocks of example process 800 may further be combined and done in parallel, in order, or out of order.

In FIG. 8, the exemplary method 800 of manufacturing a fiber optic cable with multicore optical fiber strands that can provide redundancy, facilitate expansion of a network into other areas, and accommodate greater connectivity and bandwidth demands, is shown. Method 800 begins at block 805. In block 805, the method includes forming a light guiding core. In some implementations, a light guiding core may be formed in a shape of a cylinder, rectangle, or strip. Further, light guiding cores formed within the optical fiber strand may be arranged to extend coaxially with the optical fiber strand, offset from the central axis of the optical fiber strand, or any combinations thereof. In block 810, the method includes configuring the light guiding core to provide an optical waveguide. In block 815, the method includes forming an optical fiber strand to enclose the light guiding core. In some implementations, the method may include forming a second light guiding core positioned within and enclosed by the optical fiber strand and configuring the second light guiding core as a cylindrical waveguide extending along the same axis as the optical fiber strand. As is readily contemplated, the dimensions, materials, sizes, and shapes of the optical fiber strand may be configured as desired to accommodate a plurality of light guiding cores.

In block 820, the method includes forming an outer protective layer, the outer protective layer configured to enclose the optical fiber strand and the light guiding core. In some implementations, the method may further include enclosing the outer protection layer with one or more deployment layers, the deployment layer being made of at least one of a braided steel, bronze armor wire, and a fiberglass yarn layer. Moreover, the method may include enclosing the one or more deployment layers with a second outer protection layer. The method may further include forming a combination of deployment layers to provide cut resistance, rodent protection, as well as protection from shock, vibration, temperature, humidity, UV, fungus, and chemical exposures.

In block 825, the method includes arranging the optical fiber strand, the light guiding core, and the outer protective layer to extend along a same axis. In certain embodiments, the method may further include configuring the light guiding core as a cylindrical waveguide and positioning the light guiding core to be offset a predetermined distance from the central axis of the optical fiber strand. Moreover, in certain implementations, the method may further include forming a second light guiding core positioned within and enclosed by the optical fiber strand and configuring the second light guiding core as a cylindrical waveguide extending along the same axis as the optical fiber strand and offset a predetermined distance from the central axis of the optical fiber strand.

It is noted that, although specific examples of processing steps for a printing operation have been illustrated and discussed, the order of the processing steps could be changed, if desired, and/or additional processing steps could be added.

### Definitions

A “jacket”, “protective layer,” “inner protective layer”, “deployment layer”, or “outer protective layer” as used herein includes, but is not limited to, any material or materials that may provide protection to the optical fiber device, optical fiber strands, light guiding cores, or other components of the optical fiber device. The protective layers or deployment layers may be configured as needed to withstand harsh environments such as vibrations, harsh temperatures, humidity, UV, fungus, and chemical exposures as well as provide cut resistance and rodent protection by, for example and not limited to, incorporating metals, polymers, or other rigid or hardened materials.

### Definitions and Other Embodiments

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations may be well known in the art, and because they do not facilitate a better understanding of the present disclosure, a discussion of such elements and operations is not provided herein. The present disclosure is deemed to inherently include all such elements, variations, and modifications to the described aspects that would be known to those of ordinary skill in the art, particularly in view of reading the present disclosure. Any headings used herein are for organizational purposes only and are not meant to be used to limit the scope of the description or the claims.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The term “within a proximity”, “a vicinity”, “within a vicinity”, “within a predetermined distance”, “predetermined width”, “predetermined height”, “predetermined length” and the like may be defined between about 0.01 microns and about 1.5 millimeters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 microns and about 1.5 millimeters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments and implementations.

The subject matter described herein is provided by way of illustration only and should not be construed as limiting the nature and scope of the claims herein. While different embodiments and implementations have been provided above, it is not possible to describe every conceivable combination of components or methodologies for implementing the disclosed subject matter, and one of ordinary skill in the art may recognize that further combinations and permutations that are possible. Furthermore, the nature and scope of the claims is not necessarily limited to implementations that solve any or all disadvantages which may have been noted in any part of this disclosure. Various modifications and changes may be made to the subject matter described herein without departing from the spirit and scope of, the exemplary embodiments, implementations, and applications illustrated and described herein.

Although the subject matter presented herein has been described in language specific to components used therein, it is to be understood that the scope of the claims is not necessarily limited to the specific components or characteristics thereof described herein; rather, the specific components and characteristics thereof are disclosed as example forms of implementing the disclosed subject matter. Accordingly, the disclosed subject matter is intended to embrace all alterations, modifications, and variations, that fall within the scope and spirit of any claims included herein or that may be written.

What is claimed is:

1. An optical-fiber device, comprising:
an optical fiber strand configured to include a light guiding core, the light guiding core positioned within and enclosed by the optical fiber strand; and
an outer protective layer configured to enclose the optical fiber strand and the light guiding core;
wherein the light guiding core provides an optical waveguide; and
wherein the optical fiber strand, the light guiding core, and the outer protective layer extend along a same axis.

2. The optical-fiber device of claim 1, wherein the light guiding core is a cylindrical waveguide extending coaxially with the optical fiber strand.

3. The optical-fiber device of claim 2, wherein the light guiding core is a first light guiding core and the optical fiber strand further comprises a second light guiding core configured as a cylindrical waveguide positioned within and enclosed by the optical fiber strand and extending along the same axis as the optical fiber strand.

4. The optical-fiber device of claim 1, wherein the light guiding core is a cylindrical waveguide that is offset a predetermined distance from the central axis of the optical fiber strand.

5. The optical-fiber device of claim 4, further comprising a second light guiding core configured as a cylindrical waveguide and positioned within and enclosed by the optical fiber strand, wherein the second light guiding core extends along the same axis as the optical fiber strand and is offset a predetermined distance from the central axis of the optical fiber strand.

6. The optical-fiber device of claim 4, further comprising a strength member positioned adjacent to the light guiding core and extending coaxially with the optical fiber strand.

7. The optical-fiber device of claim 1, wherein the inner perimeter of the outer protective layer is adjacent to the outer perimeter of the optical fiber strand.

8. The optical-fiber device of claim 1, wherein the outer protective layer is made of polyurethane.

9. The optical-fiber device of claim 1, further comprising a buffer layer positioned between the optical fiber strand and the outer protective layer and enclosing the optical fiber strand.

10. The optical-fiber device of claim 9, further comprising a strength member positioned between the buffer layer and the outer protective layer and enclosing the buffer layer.

11. The optical-fiber device of claim 10, further comprising an inner protective layer positioned between the strength member and the outer protective layer and enclosing the strength member.

12. The optical-fiber device of claim 1, further comprising a cladding layer enclosing the light guiding core.

13. The optical-fiber device of claim 12, further comprising an optical fiber acrylate coating enclosing the cladding layer.

14. A method of manufacturing an optical-fiber device, comprising:
forming a light guiding core;
configuring the light guiding core to provide an optical waveguide;
forming an optical fiber strand to enclose the light guiding core;
forming an outer protective layer, the outer protective layer configured to enclose the optical fiber strand and the light guiding core; and
arranging the optical fiber strand, the light guiding core, and the outer protective layer to extend along a same axis.

15. The method of claim 14, wherein forming the light guiding core further comprises forming the light guiding core as a cylindrical waveguide extending coaxially with the optical fiber strand.

16. The method of claim 15, further comprising forming a second light guiding core positioned within and enclosed by the optical fiber strand and configuring the second light guiding core as a cylindrical waveguide extending along the same axis as the optical fiber strand.

17. The method of claim 14, further comprising configuring the light guiding core as a cylindrical waveguide and positioning the light guiding core to be offset a predetermined distance from the central axis of the optical fiber strand.

18. The method of claim 17, further comprising forming a second light guiding core positioned within and enclosed by the optical fiber strand and configuring the second light guiding core as a cylindrical waveguide extending along the same axis as the optical fiber strand and offset a predetermined distance from the central axis of the optical fiber strand.

19. The method of claim 14, further comprising enclosing the outer protection layer with one or more deployment layers, the deployment layer being made of at least one of a braided steel, bronze armor wire, and a fiberglass yarn layer.

20. The method of claim 19, further comprising enclosing the one or more deployment layers with a second outer protection layer.
